(19) United States
(12) Patent Application Publication
(10) Pub. No.: US 2013/0077976 A1
(43) Pub. Date: Mar. 28, 2013

(54) TRANSMITTER AND METHOD FOR OPTICAL TRANSMISSION

(71) Applicants: Po Dong, Morganville, NJ (US); David T. Neilson, Old Bridge, NJ (US)

(72) Inventors: Po Dong, Morganville, NJ (US); David T. Neilson, Old Bridge, NJ (US)

(21) Appl. No.: 13/247,760

(22) Filed: Sep. 28, 2011

(51) Int. Cl. H04J 14/02; H04J 14/00

(52) U.S. Cl. 398/74; 398/82

(57) ABSTRACT

An optical multi-wavelength transmitter comprising an optical interleaver with at least a first optical waveguide and a second optical waveguide; a first plurality of microcavity modulators coupled to the first optical waveguide and a second plurality of microcavity modulators coupled to the second waveguide. A plurality of optical wavelengths received at an input of the interleaver are separated into a first group of separated optical wavelengths for being input in the first optical waveguide and a second group of separated optical wavelengths for being input in the second optical waveguide. Each one of the first and the second group of separated optical wavelengths have a separated wavelength spacing between adjacent separated optical wavelengths. A method of optical multi-wavelength transmission is also disclosed.

### FIELD OF THE INVENTION

The present invention relates to optical transmission. One particular and non-limiting application of the present invention is directed to the use of Orthogonal Frequency-Division Multiplexing in such optical transmission.

### BACKGROUND ART

Increasing the available bandwidth in optical transmission may allow for improving the capacity of communication in optical networks and therefore is typically highly desirable. In order to boost bandwidth in optical communications one widely used technology is the so-called Wavelength Division Multiplexing (WDM) in which a plurality of optical carrier signals are typically multiplexed and transmitted on a single optical fiber wherein the plurality of optical carriers typically have different wavelengths, thereby significantly increasing the transmission capacity as compared to the transmission of a single wavelength on a fiber.

Orthogonal Frequency-Division Multiplexing (OFDM) is a known technique which may contribute to significantly boost bandwidth capacity in optical fiber communication systems.

OFDM may be used in combination with WDM techniques and may thereby enable some improvement in bandwidth.

### SUMMARY OF THE INVENTION

In order to achieve such desired increased bandwidth capacity, an efficient transmitter may become a key component.

As a wide use of such transmitters is expected, the production of low-power, inexpensive and compact WDM transmitters may be desirable. In particular producing such transmitters based on silicon photonic circuits may be still more advantageous and thus highly desirable as it provides a more compact, less power-consuming and less expensive device as compared to conventional discrete devices.

As already mentioned, the use of OFDM transmitters in WDM transmission systems may, in particular, allow for increasing the transmission capacity while the quality of transmission as regards channel conditions, cross-talk and interferences may be maintained at desirable levels. In such applications, OFDM transmitters may typically be used for converting electrical signals into optical signals.

One known solution for providing OFDM transmitters in WDM transmission is by cascaded bulk LiNbO3 modulators used with WDM components such as for example array waveguide gratings, Echelle gratings or Mach-Zehnder interferometer-based wavelength multiplexers or optical power splitters and combiners. However such components are typically either discrete or, in any case, are typically not suitable for producing highly advanced modulation formats which typically require integration of a large number of optical components. Discrete components also occupy more space as compared to photonic circuits thereby causing a further drawback with respect to such solutions. Furthermore, methods using such components typically have a relatively high power consumption and insertion loss, also they are typically expensive and not easy to use.

Some embodiments of the present disclosure are directed to an optical multi-wavelength transmitter comprising:

an optical interleaver comprising at least a first optical waveguide and a second optical waveguide;

a first plurality of microcavity modulators coupled to the first optical waveguide and a second plurality of microcavity modulators coupled to the second waveguide.

According to some specific embodiments the optical interleaver is configured for separating a plurality of optical wavelengths received at an input of the interleaver into a first group of separated optical wavelengths for being input in the first optical waveguide and a second group of separated optical wavelengths for being input in the second optical waveguide, each one of the first and the second group of separated optical wavelengths comprising a separated wavelength spacing between adjacent separated optical wavelengths.

According to some specific embodiments each microcavity modulator has a resonant wavelength matching a respective one of said separated optical wavelengths, each one of said microcavity modulators being configured for modulating said respective one of the separated optical wavelengths.

According to some specific embodiments the plurality of optical wavelengths received at an input of the interleaver have an input wavelength spacing between adjacent received optical wavelengths, and said separated wavelength spacing is larger than said input wavelength spacing.

According to some specific embodiments the interleaver comprises N waveguides, where N is a positive integer equal or greater than 2, and is configured for separating said plurality of optical wavelengths received at an input of the interleaver into N groups of separated optical wavelengths, each group of separated optical wavelengths being input in a respective one of the N optical waveguides, each one of the N groups of separated optical wavelengths comprising a separated wavelength spacing between adjacent separated optical wavelengths.

According to some specific embodiments, said separated wavelength spacing is N times the input wavelength spacing.

According to some specific embodiments the transmitter comprises an optical coupler configured for coupling optical wavelengths modulated by said microcavity modulators and received from said first waveguide and said second waveguide into an output.

According to some specific embodiments each one of said microcavity modulators is configured for being driven by a respective electrical signal and is configured for encoding said electrical signal into an optical signal.

According to some specific embodiments a plurality of microcavity modulators are disposed in a cascaded structure using a common bus waveguide configured for modulating and multiplexing said separated optical wavelengths.

According to some specific embodiments, the transmitter may be a WDM transmitter or an OFDM transmitter configured for operating using WDM transmission.

Some embodiments of the present disclosure are directed to an optical network comprising the transmitter as disclosed herein. The optical network may be a long-haul network, or a metro network or an access network.

Some embodiments of the present disclosure are directed to a method of optical transmission comprising:

receiving a plurality of optical wavelengths;

separating the plurality of optical wavelengths into a first group of separated optical wavelengths and a second group of separated optical wavelengths;

inputting in a first optical waveguide the first group of separated optical wavelengths;

inputting in a second optical waveguide the second group of separated optical wavelengths;

wherein the first group of separated optical wavelengths and the second group of separated optical wavelengths each comprise a separated wavelength spacing between adjacent separated optical wavelengths; and

modulating each separated optical wavelength by means of a respective microcavity modulator, the respective microcavity modulator having a resonant wavelength matching said separated optical wavelength.

According to some specific embodiments the plurality of optical wavelengths received at an input of the interleaver have an input wavelength spacing between adjacent received optical wavelengths, and said separated wavelength spacing is larger than said input wavelength spacing.

According to some specific embodiments the interleaver comprises N waveguides, where N is a positive integer equal or greater than 2 and the method comprises separating said plurality of optical wavelengths received at an input of the interleaver into N groups of separated optical wavelengths, and inputting each group of separated optical wavelengths in a respective one of the N optical waveguides, each one of the N groups of separated optical wavelengths comprising a separated wavelength spacing between adjacent separated optical wavelengths.

According to some specific embodiments for an interleaver comprising N waveguides, the plurality of optical wavelengths received at an input of the interleaver have an input wavelength spacing between adjacent received optical wavelengths, and said separated wavelength spacing is larger than said input wavelength spacing.

In some specific embodiments such separated wavelength spacing is N times the input wavelength spacing.

According to some specific embodiments modulating the separated optical wavelengths by a microcavity modulator is performed by applying a respective electrical signal and encoding said electrical signal into an optical signal.

According to some specific embodiments the method comprises multiplexing the modulated optical wavelengths by arranging the plurality of microcavity modulators in a cascaded structure using a common bus waveguide.

These and further features and advantages of the present invention are described in more detail, for the purpose of illustration and not limitation, in the following description as well as in the claims with the aid of the accompanying drawing.

### BRIEF DESCRIPTION OF THE DRAWINGS

FIG. 1 is an exemplary schematic representation of an optical transmitter according to some embodiments.

### DETAILED DESCRIPTION

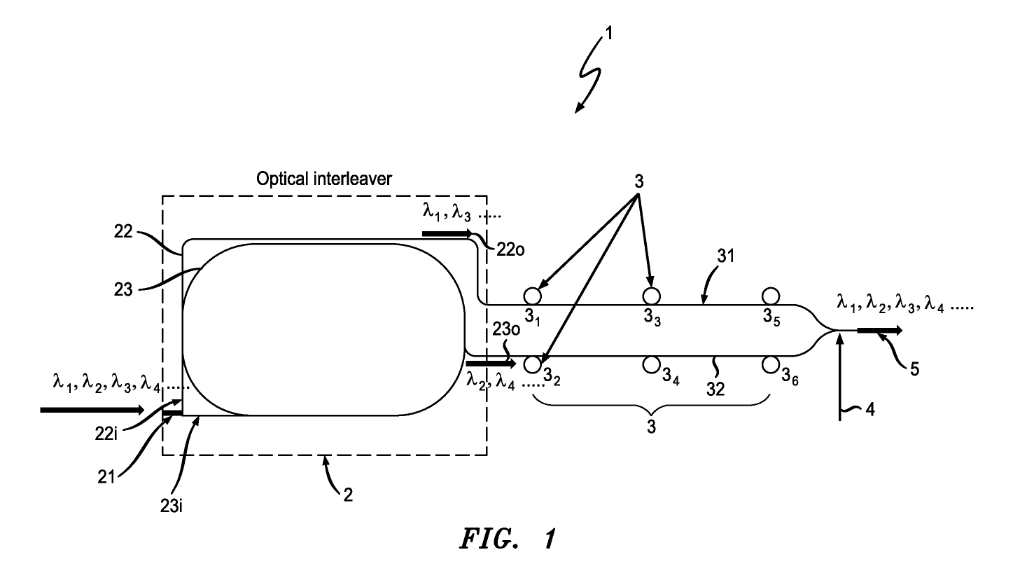

Referring to FIG. 1, the transmitter 1 comprises an optical interleaver 2 comprising at least a first waveguide 22 and a second waveguide 23.

In the example shown in FIG. 1, only two waveguides are shown, however this is only exemplary. The interleaver may comprise any convenient number N of waveguides where N is a positive integer equal or greater than 2.

The interleaver 2 is configured for receiving at input port 21 a plurality of optical wavelengths λ₁, λ₂, λ₃, λ₄ . . . . Said plurality of optical wavelengths may be received by the interleaver for example from a CW multiple wavelength or broadband light laser source. The waveguides may provide separate optical paths for optical signals at respective inputs thereof.

The plurality of optical wavelengths λ₁, λ₂, λ₃, λ₄ received at input 21 of the interleaver 2 are then separated into a first group of separated wavelengths λ₁, for being input in the first waveguide 22 through a first input port 22_{I} and a second group of separated wavelengths λ₂, λ₄, . . . , for being input in the second waveguide 23 through a second input port 23_{I}. Such separation may be performed by means of a single optical ring or a MZI with an input and at least two outputs capable of separating the incoming plurality of wavelengths into at least two groups corresponding to the ring or MZI's free spectral ranges.

Each one of the first group of separated wavelengths and the second group of separated wavelengths comprises a separated wavelength spacing (in terms of wavelength) between adjacent separated wavelengths.

Each one of the first group of separated wavelengths and the second group of separated wavelengths is then output from a respective output port 22_{O} and 23_{O} into a respective first and second coupling waveguide 31 and 32.

The optical interleaver 2 is preferably a single ring, a high-order ring filter, a MZI, or other types of known interleavers capable of separating the incoming wavelengths by a desired spacing.

The transmitter further comprises a plurality of optical microcavity modulators, shown in the FIGURE by the general reference numeral 3.

Optical microcavity modulators are known devices. As a brief non-limiting explanation, an optical microcavity typically comprises reflective elements placed on the sides of a spacing, located between the reflective elements. Such spacing may provide what is typically known as an optical cavity which may provide similar functions as those of an optical cavity in a standard laser device. However, microcavities typically have smaller dimensions as compared to those of a cavity in a standard laser.

For the purpose of the present disclosure, each microcavity modulator may be capable of blocking one optical wavelength from a plurality of wavelengths received—which is the wavelength matching its resonant wavelength—and allowing to pass the rest of the wavelengths (not matching its resonant wavelength) from said plurality of wavelength.

The use of microcavity modulators is advantageous as compared to standard larger size modulators such as MZI modulators because microcavity modulators are compact devices with a relatively low power consumption, may be easy to manufacture as photonic circuits with large scale integration and have the capability of demultiplexing and multiplexing optical wavelengths.

Some of the plurality of microcavity modulators 3 are coupled to the first coupling waveguide 31 and some are coupled to the second coupling waveguide 32. In the FIGURE, microcavity modulators 3₁, 3₃ and 3₅ are shown to be coupled to the first coupling waveguide 31 and microcavity modulators 3₂, 3₄ and 3₆ are shown to be coupled to the second coupling waveguide 32.

Each one of the plurality of the microcavity modulators has a resonant wavelength matching a respective one of the wavelengths conveyed in the respective waveguide to which that microcavity is coupled. For example in FIG. 1 it may be assumed that microcavity 3₁ has a resonant frequency matching the wavelength λ₁, microcavity 3₂ has a resonant frequency matching the wavelength λ₂, microcavity 3₃ has a resonant frequency matching the wavelength 3, and so on.

Each one of said microcavity modulators 3 is configured for modulating said respective one of received wavelengths. This may be done for example by applying an electrical signal which may be provided by an external source to a microcavity modulator which is configured for encoding said electrical signal into an optical signal, thereby generating a modulated optical signal at a wavelength matching the wavelength which was blocked by that particular microcavity modulator (and which matches the resonant frequency of the microcavity modulator). The encoded optical signal is then output from the microcavity modulator as an output signal to be used for transmission.

In order to provide a multiplexed output signal a plurality of microcavity modulators may be cascaded using a common bus waveguide configured for modulating and multiplexing said received wavelengths. In the FIGURE, microcavity modulators 3₁, 3₃ and 3₅ are shown to be cascaded on the common waveguide 31 thereby producing at the output of the waveguide 31 a modulated and multiplexed signal comprising the wavelengths conveyed on the waveguide 31. Likewise, microcavity modulators 3₂, 3₄ and 3₆ are shown to be cascaded on the common waveguide 32 thereby producing at the output of the waveguide 32 a modulated and multiplexed signal comprising the wavelengths conveyed on the waveguide 32.

The spacing provided by the interleaver between the adjacent separated wavelengths may advantageously allow for sufficient space between the adjacent wavelengths thus enabling the microcavity modulators to demultiplex, modulate and multiplex the wavelengths. If such separation is not provided, the wavelengths may be too close to each other such the microcavity modulator is not capable of distinguishing between the wavelengths in order to demultiplex, modulate and modulate them.

In some embodiments the plurality of the optical wavelengths λ1, λ2, λ3, λ4 input at the input port 21 comprise a spacing between adjacent input optical wavelengths λ1, λ2, λ3, λ4. This may be the case for OFDM applications and therefore the transmitter is an OFDM transmitter. In such cases, the modulation data rate may be matching such wavelength spacing at the input port 21.

Such input wavelength spacing AA is preferably the same between all the wavelengths in the plurality of input optical wavelengths λ1, λ2, λ3, λ4.

In such embodiments, the separated wavelength spacing is preferably larger than said input wavelength spacing Δλ.

In case the interleaver has only 2 waveguides, the separated wavelength spacing is preferably about twice the input wavelength spacing Δλ.

In case the interleaver comprises N waveguides for N>2, then the interleaver may separate the plurality of input wavelengths into N groups of separated wavelengths and each one of said groups separated wavelengths preferably comprises a spacing between adjacent wavelengths in each one of said groups of separated wavelengths of about N times the input wavelength spacing Δλ. (namely, NΔλ)

Preferably the transmitter 1 further comprises an optical output coupler 4 configured for coupling the modulated and multiplexed wavelengths output from the first waveguide 31 and the modulated and multiplexed wavelengths output from the first waveguide 32 thereby producing a multiplexed signal at an output port 5 thereof. The output multiplexed signal comprises a multiplex of the plurality of optical wavelengths λ₁, λ₂, λ₃, λ₄ after said optical wavelengths have been modulated by the microcavity modulators as described above.

It is to be noted that the list of structures corresponding to the claimed means is not exhaustive and that one skilled in the art understands that equivalent structures can be substituted for the recited structure without departing from the scope of the invention.

Some non-limiting examples of structures corresponding to the claimed means may be a Mach-Zehnder interferometer as an interleaver, ring resonators, racetrack resonators, disk resonators or photonic crystal resonators as microcavity modulators and the use of directional couplers or multimode interference couplers or WDM filters as output coupler.

The various embodiments of the present invention may be combined as long as such combination is compatible and/or complimentary.

It is also to be noted that the order of the steps of the method of the invention as described and recited in the corresponding claims is not limited to the order as presented and described and may vary without departing from the scope of the invention.

It should be appreciated by those skilled in the art that the block diagram herein represents conceptual views of illustrative circuitry embodying the principles of the invention.

What is claimed is:

1. An optical multi-wavelength transmitter comprising:
an optical interleaver comprising at least a first optical waveguide and a second optical waveguide;
a first plurality of microcavity modulators coupled to the first optical waveguide and a second plurality of microcavity modulators coupled to the second waveguide.

2. The transmitter of claim 1 wherein the optical interleaver is configured for separating a plurality of optical wavelengths received at an input of the interleaver into a first group of separated optical wavelengths for being input in the first optical waveguide and a second group of separated optical wavelengths for being input in the second optical waveguide, each one of the first and the second group of separated optical wavelengths comprising a separated wavelength spacing between adjacent separated optical wavelengths.

3. The transmitter of claim 1 wherein each microcavity modulator has a resonant wavelength matching a respective one of said separated optical wavelengths, each one of said microcavity modulators being configured for modulating said respective one of the separated optical wavelengths.

4. The transmitter of claim 2 wherein the plurality of optical wavelengths received at an input of the interleaver have an input wavelength spacing between adjacent received optical wavelengths, and said separated wavelength spacing is larger than said input wavelength spacing.

5. The transmitter of claim 2 wherein the interleaver comprises N waveguides, where N is a positive integer equal or greater than 2, and is configured for separating said plurality of optical wavelengths received at an input of the interleaver into N groups of separated optical wavelengths, each group of separated optical wavelengths being input in a respective one of the N optical waveguides, each one of the N groups of separated optical wavelengths comprising a separated wavelength spacing between adjacent separated optical wavelengths.

6. The transmitter if claim 5 wherein the plurality of optical wavelengths received at an input of the interleaver have an input wavelength spacing between adjacent received optical wavelengths, and said separated wavelength spacing is larger than said input wavelength spacing.

7. The transmitter of claim 6 wherein said separated wavelength spacing is N times the input wavelength spacing.

8. The transmitter of claim 1 wherein the transmitter comprises an optical coupler configured for coupling optical wavelengths modulated by said microcavity modulators and received from said first waveguide and said second waveguide into an output.

9. The transmitter of claim 1 wherein each one of said microcavity modulators is configured for being driven by a respective electrical signal and is configured for encoding said electrical signal into an optical signal.

10. The transmitter of claim 2 wherein a plurality of microcavity modulators are disposed in a cascaded structure using a common bus waveguide configured for modulating and multiplexing said separated optical wavelengths.

11. The transmitter of claim 1 wherein the transmitter is WDM transmitter or an OFDM transmitter configured for operating using WDM transmission.

12. An optical network comprising the transmitter of claim 1.

13. A method of optical transmission comprising:
receiving a plurality of optical wavelengths;
separating the plurality of optical wavelengths into a first group of separated optical wavelengths and a second group of separated optical wavelengths;
inputting in a first optical waveguide the first group of separated optical wavelengths;
inputting in a second optical waveguide the second group of separated optical wavelengths;
wherein the first group of separated optical wavelengths and the second group of separated optical wavelengths each comprise a separated wavelength spacing between adjacent separated optical wavelengths; and
modulating each separated optical wavelength by means of a respective microcavity modulator, the respective microcavity modulator having a resonant wavelength matching said separated optical wavelength.

14. The method of claim 13 wherein the plurality of optical wavelengths received at an input of the interleaver have an input wavelength spacing between adjacent received optical wavelengths, and said separated wavelength spacing is larger than said input wavelength spacing.

15. The method of claim 13 wherein the interleaver comprises N waveguides, where N is a positive integer equal or greater than 2 and the method comprises separating said plurality of optical wavelengths received at an input of the interleaver into N groups of separated optical wavelengths, and inputting each group of separated optical wavelengths in a respective one of the N optical waveguides, each one of the N groups of separated optical wavelengths comprising a separated wavelength spacing between adjacent separated optical wavelengths.

16. The method of claim 15 wherein the plurality of optical wavelengths received at an input of the interleaver have an input wavelength spacing between adjacent received optical wavelengths, and said separated wavelength spacing is larger than said input wavelength spacing.

17. The method of claim 16 wherein said separated wavelength spacing is N times the input wavelength spacing

18. The method of claim 13 wherein modulating the separated optical wavelengths by a microcavity modulator is performed by applying a respective electrical signal and encoding said electrical signal into an optical signal.

19. The method of claim 13 wherein the method comprises multiplexing the modulated optical wavelengths by arranging the plurality of microcavity modulators in a cascaded structure using a common bus waveguide.
